(19) United States
(12) Patent Application Publication
(10) Pub. No.: US 2019/0159236 A1
(43) Pub. Date: May 23, 2019

(54) RESOURCE SCHEDULING METHOD AND APPARATUS

(71) Applicant: HUAWEI TECHNOLOGIES CO., LTD., Shenzhen (CN)

(72) Inventors: Xiaoying XU, Shanghai (CN); Xiaoxiao ZHENG, Shanghai (CN); Qinghai ZENG, Shanghai (CN); Min XU, Shenzhen (CN)

(21) Appl. No.: 16/252,534

(22) Filed: Jan. 18, 2019

Related U.S. Application Data
(63) Continuation of application No. PCT/CN2017/085524, filed on May 23, 2017.

(30) Foreign Application Priority Data
Aug. 11, 2016 (CN) 201610665452.0

(51) Int. Cl. H04W 72/12; H04W 72/14; H04W 76/30; H04W 76/18

(52) U.S. Cl. CPC H04W 72/1284; H04W 72/14; H04W 76/18; H04W 76/30; H04W 72/1242

(57) ABSTRACT

Embodiments of the present invention are related to a resource scheduling method and apparatus, so as to reduce a sending latency of resource scheduling to meet a sending latency requirement of a future service. The method includes: when determining that a service that needs to be carried meets a trigger condition of sending a resource scheduling request, sending, by a terminal, the resource scheduling request to a base station, where the resource scheduling request is used to request the base station to allocate an uplink resource to the terminal, and the resource scheduling request includes at least one of a priority indication of the service, a scheduling-free sending indication, a scheduling-free sending failure indication, a semi-persistent resource request, and a data buffer size indication; and allocating, by the base station, the uplink resource to the terminal based on the resource scheduling request. In such resource scheduling manner, a sending latency of a service can be reduced.

### CROSS-REFERENCE TO RELATED APPLICATIONS

This application is a continuation of International Application No. PCT/CN2017/085524, filed on May 23, 2017, which claims priority to Chinese Patent Application No. 201610665452.0, filed on Aug. 11, 2016. The disclosures of the aforementioned applications are hereby incorporated by reference in their entireties.

### TECHNICAL FIELD

Embodiments of the present invention related to communications field, and in particular, to a resource scheduling method and apparatus.

### BACKGROUND

A next generation mobile network (NGMN), such as a future 5G mobile communications system, needs to support a conventional mobile broadband (MBB) service, and further needs to support various using services having different requirements. The NGMN roughly divides future services into an evolved MBB (eMBB) service, a massive machine type communication (mMTC) service, and an ultra-reliable and low latency communications (URLLC) service. These services impose different requirements on a network. For example, the eMBB service requires the network to provide high bandwidth and a low latency; the mMTC service is insensitive to a latency, but requires the network to provide an extra-large quantity of connections; and the URLLC service requires the network to provide extremely high reliability and an extremely low end-to-end latency, and an uplink sending latency requirement for the URLLC service is 0.5 ms according to a latency requirement of next-generation wireless communication.

In a current Long Term Evolution (LTE) system, when a terminal (UE) is in a connected mode and has no uplink grant, the terminal first sends a scheduling request (SR) on a physical uplink control channel (PUCCH), to request a base station to allocate a small quantity of resources. After obtaining the uplink grant, the terminal sends a buffer status report (BSR), and the BSR includes a logical channel and a requested data buffer size. The base station allocates an uplink grant based on a priority of the logical channel and the requested data buffer size in the BSR, and the UE sends data after obtaining the uplink grant. Based on a current TTI (Transmission Time Interval) of 1 ms, a scheduling request process of SR+BSR requires approximately 15 ms. If the TTI is reduced to 0.1 ms, a sending latency is approximately 2 ms when there is no retransmission. Therefore, a sending latency requirement of a future service cannot be met.

### SUMMARY

Embodiments of the present invention provide a resource scheduling method and apparatus, so as to reduce a sending latency of resource scheduling to meet a sending latency requirement of a future service.

Specific technical solutions provided in the embodiments of the present invention are as follows.

According to a first aspect, a resource scheduling method is provided, including:

determining, by a terminal, that a service that needs to be carried meets a trigger condition of sending a resource scheduling request; and

sending, by the terminal, the resource scheduling request to a base station, where the resource scheduling request is used to request the base station to allocate an uplink resource to the terminal, and the resource scheduling request includes at least one of a priority indication of the service, a scheduling-free sending indication, a scheduling-free sending failure indication, a semi-persistent resource request, or a data buffer size indication.

In one embodiment, the determining, by a terminal, that a service that needs to be carried meets a trigger condition of resource scheduling includes:

when a data buffer size is empty, and new data of the service arrives, determining, by the terminal, that the trigger condition of the resource scheduling request is met; or

when data that is of the service and that is carried on a channel, a slice, or an IP flow whose priority indication meets a preset condition arrives, determining, by the terminal, that the trigger condition of the resource scheduling request is met; or

when determining that a service data volume of a service that is in the service and that is carried on a channel, a slice, or an IP flow whose priority indication meets a preset condition is greater than a first preset threshold, determining, by the terminal, that the trigger condition of the resource scheduling request is met; or

when determining that a service data volume of the service is greater than a second preset threshold, determining, by the terminal, that the trigger condition of the resource scheduling request is met; or

when determining that a service data volume of a scheduling-free service in the service is greater than a third preset threshold, determining, by the terminal, that the trigger condition of the resource scheduling request is met; or

when determining that a data buffer size of a scheduling-based service in the service is greater than a fourth preset threshold, determining, by the terminal, that the trigger condition of the resource scheduling request is met; or

when determining that a quantity of times that a scheduling-free service in the service fails to be sent is greater than a fifth preset threshold, determining, by the terminal, that the trigger condition of the resource scheduling request is met.

In the embodiment, when the trigger condition of the resource scheduling request is met, the terminal sends the resource scheduling request to the base station, so that the trigger condition of the resource scheduling request may be flexibly set based on an actual case, thereby meeting latency requirements of various services.

In one embodiment, the semi-persistent resource request includes service bearer information or a semi-persistent resource request instruction that is used to instruct the base station to allocate a semi-persistent resource.

In one embodiment, the scheduling-free sending indication includes resource information used to indicate that the terminal performs scheduling-free sending.

In one embodiment, before the determining, by a terminal, that a service that needs to be carried meets a trigger condition of sending a resource scheduling request, the method further includes:

determining, by the terminal, that data of the service is carried on a pre-agreed logical channel, a specified slice, or a specified IP flow; or

determining, by the terminal, that data of the service is carried on a logical channel configured on a network side, a specified slice, or a specified IP flow.

According to a second aspect, a resource scheduling method is provided, including:

receiving, by a base station, a resource scheduling request sent by a terminal, where the resource scheduling request is used to request the base station to allocate an uplink resource to the terminal, and the resource scheduling request includes at least one of a priority indication of the service, a scheduling-free sending indication, a scheduling-free sending failure indication, a semi-persistent resource request, and a data buffer size indication; and

allocating, by the base station, the uplink resource to the terminal based on the resource scheduling request.

In one embodiment, the semi-persistent resource request includes service bearer information or a semi-persistent resource request instruction that is used to instruct the base station to allocate a semi-persistent resource.

In one embodiment, the allocating, by the base station, the uplink resource to the terminal based on the resource scheduling request includes:

allocating, by the base station, a corresponding uplink grant to the terminal based on the scheduling-free sending indication, the scheduling-free sending failure indication, or the data buffer size indication in the resource scheduling request; and

determining, by the base station, a latency of the uplink grant based on the priority indication in the resource scheduling request.

In this embodiment, the base station can allocate appropriate uplink resources for different services based on various information of services carried in the scheduling request sent by the terminal, so as to increase resource usage, and flexibly schedule a resource.

In one embodiment, the allocating, by the base station, the uplink resource to the terminal based on the resource scheduling request includes:

when determining that the service bearer information in the resource scheduling request meets a preset condition, allocating, by the base station, the semi-persistent resource to the terminal; or

when determining that the resource scheduling request includes the semi-persistent resource request instruction that instructs the base station to allocate the semi-persistent resource, allocating, by the base station, the semi-persistent resource to the terminal.

In this embodiment, the base station can allocate the semi-persistent resource to the terminal based on the service bearer information or indication that requests the base station to allocate the semi-persistent resource and that is carried in the scheduling request sent by the terminal, so that the terminal can enable, by sending the resource scheduling request once, the base station to allocate the semi-persistent resource that is used for a plurality of times, thereby reducing scheduling costs.

In one embodiment, after the allocating, by the base station, the semi-persistent resource to the terminal, the method further includes:

when the base station detects that the service bearer information of the terminal does not meet the preset condition, actively releasing, by the base station, the semi-persistent resource, or instructing the terminal to release the semi-persistent resource.

In this embodiment, when a service subsequently sent by the terminal does not meet a preset bearer condition of the semi-persistent resource, the semi-persistent resource is released, so as to increase resource usage.

According to a third aspect, a resource scheduling apparatus is provided, and the resource scheduling apparatus is applied to a terminal, and includes:

a processing unit, configured to determine that a service that needs to be carried meets a trigger condition of sending a resource scheduling request; and

a sending unit, configured to send the resource scheduling request to a base station, where the resource scheduling request is used to request the base station to allocate an uplink resource to the terminal, and the resource scheduling request includes at least one of a priority indication of the service, a scheduling-free sending indication, a scheduling-free sending failure indication, a semi-persistent resource request, or a data buffer size indication.

In one embodiment, when determining that the service that needs to be carried meets the trigger condition of resource scheduling, the processing unit is specifically configured to:

when a data buffer size is empty, and new data of the service arrives, determine that the trigger condition of the resource scheduling request is met; or

when data that is of the service and that is carried on a channel, a slice, or an IP flow whose priority indication meets a preset condition arrives, determine that the trigger condition of the resource scheduling request is met; or

when determining that a service data volume of a service that is in the service and that is carried on a channel, a slice, or an IP flow whose priority indication meets a preset condition is greater than a first preset threshold, determine that the trigger condition of the resource scheduling request is met; or

when determining that a service data volume of the service is greater than a second preset threshold, determine that the trigger condition of the resource scheduling request is met; or

when determining that a service data volume of a scheduling-free service in the service is greater than a third preset threshold, determine that the trigger condition of the resource scheduling request is met; or

when determining that a data buffer size of a scheduling-based service in the service is greater than a fourth preset threshold, determine that the trigger condition of the resource scheduling request is met; or

when determining that a quantity of times that a scheduling-free service in the service fails to be sent is greater than a fifth preset threshold, determine that the trigger condition of the resource scheduling request is met.

In one embodiment, the semi-persistent resource request includes service bearer information or a semi-persistent resource request instruction that is used to instruct the base station to allocate a semi-persistent resource.

In one embodiment, the scheduling-free sending indication includes resource information used to indicate that the terminal performs scheduling-free sending.

In one embodiment, the processing unit is further configured to:

before determining that the service that needs to be carried meets the trigger condition of sending the resource scheduling request, determine that data of the service is carried on a pre-agreed logical channel, a specified slice, or a specified IP flow; or

determine that data of the service is carried on a logical channel configured on a network side, a specified slice, or a specified IP flow.

According to a fourth aspect, a resource scheduling apparatus is provided, including:

a receiving unit, configured to receive a resource scheduling request sent by a terminal, where the resource scheduling request is used to request a base station to allocate an uplink resource to the terminal, and the resource scheduling request includes at least one of a priority indication of the service, a scheduling-free sending indication, a scheduling-free sending failure indication, a semi-persistent resource request, or a data buffer size indication.

a processing unit, configured to allocate the uplink resource to the terminal based on the resource scheduling request.

In one embodiment, the semi-persistent resource request includes service bearer information or a semi-persistent resource request instruction that is used to instruct the base station to allocate a semi-persistent resource.

In one embodiment, when allocating the uplink resource to the terminal based on the resource scheduling request, the processing unit is specifically configured to:

allocate a corresponding uplink grant to the terminal based on the scheduling-free sending indication, the scheduling-free sending failure indication, or the data buffer size indication in the resource scheduling request; and

determine a latency of the uplink grant based on the priority indication in the resource scheduling request.

In one embodiment, when allocating the uplink resource to the terminal based on the resource scheduling request, the processing unit is specifically configured to:

when determining that the service bearer information in the resource scheduling request meets a preset condition, allocate the semi-persistent resource to the terminal; or

when determining that the resource scheduling request includes the semi-persistent resource request instruction that instructs the base station to allocate the semi-persistent resource, allocate the semi-persistent resource to the terminal.

In one embodiment, the processing unit is further configured to:

after the semi-persistent resource is allocated to the terminal, and when it is detected that the service bearer information of the terminal does not meet the preset condition, actively release, by the base station, the semi-persistent resource, or instruct the terminal to release the semi-persistent resource.

According to a fifth aspect, a terminal is provided. The terminal includes a processor, a memory, and a transmitter, where the memory stores a computer readable program, and the processor controls the transmitter by running the program in the memory, so as to implement the resource scheduling method in the first aspect.

According to a sixth aspect, a network device is provided. The network device includes a processor, a memory, and a receiver, where the memory stores a computer readable program, and the processor controls the receiver by running the program in the memory, so as to implement the resource scheduling method in the second aspect.

According to a seventh aspect, this application provides a computer storage medium, configured to store a computer software instruction that is used by the terminal in the foregoing first aspect and the second aspect, where the computer software instruction includes a program designed to perform the foregoing aspects.

According to an eighth aspect, this application provides a computer storage medium, configured to store a computer software instruction that is used by the base station in the foregoing first aspect and the second aspect, where the computer software instruction includes a program designed to perform the foregoing aspects.

It can be learned that in the foregoing aspects, when determining that the service that needs to be carried meets the trigger condition of sending the resource scheduling request, the terminal sends the resource scheduling request to the base station, so that the base station flexibly allocates, based on the resource scheduling request sent by the terminal, the uplink resource to the terminal. Compare with a prior-art resource scheduling method, a proper scheduling resource can be obtained by sending the resource scheduling request once, so that resource usage is high, and transmission latencies of various future services can be met.

### BRIEF DESCRIPTION OF DRAWINGS

FIG. 1 is an architectural diagram of an LTE system;

FIG. 2 is a flowchart of a resource scheduling method according to an embodiment of the present invention;

FIG. 3 is a schematic structural diagram of a resource scheduling apparatus according to an embodiment of the present invention;

FIG. 4 is a schematic structural diagram of a terminal device according to an embodiment of the present invention;

FIG. 5 is a schematic structural diagram of a resource scheduling apparatus according to an embodiment of the present invention;

FIG. 6 is a schematic structural diagram of a network device according to an embodiment of the present invention.

FIG. 7 is a schematic structural diagram of a terminal according to an embodiment of the present invention; and

FIG. 8 is a schematic structural diagram of a base station according to an embodiment of the present invention.

### DESCRIPTION OF EMBODIMENTS

The following clearly and completely describes the technical solutions in the embodiments of the present invention with reference to the accompanying drawings in the embodiments of the present invention. Apparently, the described embodiments are merely some but not all of the embodiments of the present invention. All other embodiments obtained by persons of ordinary skill in the art based on the embodiments of the present invention without creative efforts shall fall within the protection scope of the present invention.

It should be understood that in the embodiments of the present invention, a terminal may be referred to as user equipment (UE for short), a mobile station (MS for short), a mobile terminal, or the like. The terminal may communicate with one or more core network devices through a radio access network (RAN for short), for example, the terminal may be a mobile phone (alternatively referred to as a “cellular” phone) or a computer with a mobile terminal, for example, the terminal may further be a portable, pocket-sized, handhold, computer built-in, or in-vehicle mobile apparatus, which exchanges voice and/or data with the radio access network.

It should be understood that in the embodiments of the present invention, a base station may be alternatively referred to as a radio access network (RAN) device, which is a device that connects the terminal and a wireless network, and includes but is not limited to an evolved NodeB (eNB), a radio network controller (RNC), a NodeB (NB), a base station controller (BSC), a base transceiver station (BTS), a home eNodeB (for example, Home evolved NodeB or Home NodeB, HNB), a baseband unit (BBU), a WiFi access point (AP), or the like.

It should be further understood that the technical solutions provided in the embodiments of the present invention may be applied to various communications systems, such as a global system for mobile communications (GSM for short), a Code Division Multiple Access (CDMA for short) system, a Wideband Code Division Multiple Access (WCDMA for short) system, a general packet radio service (GPRS for short) system, a Long Term Evolution (LTE for short) system, and a future evolved system, such as a 5G system.

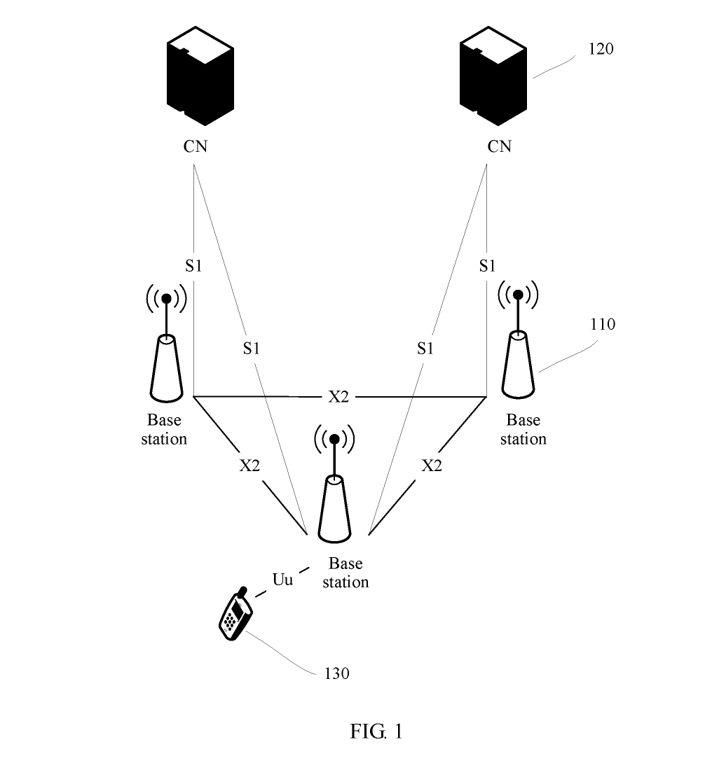

In the embodiments of the present invention, that the technical solutions are applied to the LTE system is used as an example for description. FIG. 1 is an architectural diagram of an LTE system. The LTE system includes base stations 110, core network (Core Network, CN) devices 120, and a terminal 130. The terminal 130 accesses a wireless network by using the base station 110, and communication between the terminal 130 and an external network is implemented by using the CN device 120. In the system, the base stations 110 may exchange information. For example, in a Long Term Evolution (LTE) system, an interface between the base stations is referred to as an X2 interface, and the base stations 110 may exchange information by using the X2 interface. In addition, an interface between the base station 110 and the terminal 130 is referred to as a Uu interface, or referred to as an air interface, and the base station 110 communicates with the terminal 130 by using the air interface. An interface between the base station 110 and the CN device 120 is referred to as an S1 interface, and the base station 110 communicates with the CN device 120 by using the S1 interface. The CN device 120 may include a mobility management entity (MME) and a serving gateway (S-GW). The base station 110 and the S-GW exchange user-plane information, and the base station 110 and the MME exchange control-plane information. Details are not described herein.

The embodiments of the present invention provide a resource scheduling method and apparatus, so as to reduce a sending latency of resource scheduling to meet a sending latency requirement of a future service. The method and the apparatus are based on a same inventive concept. Because a problem-resolving principle of the method is similar to that of the apparatus, mutual reference may be made between implementation of the apparatus and implementation of the method, and no repeated description is provided.

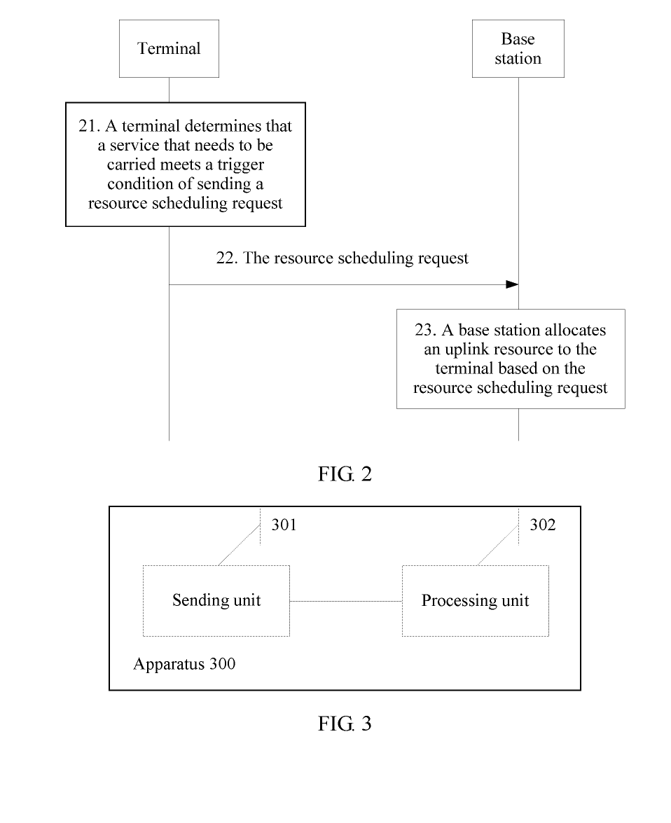

Based on the network architecture shown in FIG. 1, referring to FIG. 2, an embodiment of the present invention provides a resource scheduling method, and a specific procedure includes the following operations.

Operation 21: A terminal determines that a service that needs to be carried meets a trigger condition of sending a resource scheduling request.

Further, before the terminal determines that the service that needs to be carried meets the trigger condition of sending the resource scheduling request, an application manner of the resource scheduling request further needs to be configured in the method, and specifically includes the following two manners:

Manner 1: When determining that data of the service is carried on a pre-agreed logical channel, slice, or IP flow, the terminal can further determine whether the service meets the trigger condition of sending the resource scheduling request.

Manner 2: When determining that data of the service is carried on a logical channel, a slice, or an IP flow that is configured on a network side, the terminal can further determine whether the service meets the trigger condition of sending the resource scheduling request. In this case, the configuration on the network side may be performed on a per-terminal basis, and the terminal may be configured, by using dedicated or common signaling, with the logical channel, the slice, or the IP flow that is configured on the network side.

For example, the determining, by a terminal, that a service that needs to be carried meets a trigger condition of resource scheduling includes any one of the following cases:

Case 1: When a data buffer size is empty, and new data of the service arrives, the terminal determines that the trigger condition of the resource scheduling request is met.

Case 2: When data that is of the service and that is carried on a channel, a slice, or an IP flow whose priority indication meets a preset condition arrives, the terminal determines that the trigger condition of the resource scheduling request is met.

Case 3: When determining that a service data volume of a service that is in the service and that is carried on a channel, a slice, or an IP flow whose priority indication meets a preset condition is greater than a first preset threshold, the terminal determines that the trigger condition of the resource scheduling request is met.

Case 4: When determining that a service data volume of the service is greater than a second preset threshold, the terminal determines that the trigger condition of the resource scheduling request is met.

Case 5: When determining that a service data volume of a scheduling-free service in the service is greater than a third preset threshold, the terminal determines that the trigger condition of the resource scheduling request is met.

It should be noted that a priority includes a plurality of levels, for example, a high priority and a low priority. A priority indication of the high priority is represented by 1, and a priority indication of the low priority is represented by 0. That the priority indication meets the preset condition in Case 2 or Case 3 is the case of the high priority whose priority indication is 1.

It should be noted that in this embodiment of the present invention, a network does not need to allocate a resource before data of the scheduling-free service is sent. When the terminal is in a connected mode, the terminal obtains one resource or one group of resources that are pre-configured by the network, and when service data needs to be sent, the terminal directly uses the one resource or the one group of resources that are configured by the network. When the terminal is in an idle mode, the terminal obtains a scheduling-free resource indicated in a broadcast message, and directly uses the scheduling-free resource when service data needs to be sent.

Case 6: When determining that a data buffer size of a scheduling-based service in the service is greater than a fourth preset threshold, the terminal determines that the trigger condition of the resource scheduling request is met.

Case 7: When determining that a quantity of times that a scheduling-free service in the service fails to be sent is greater than a fifth preset threshold, the terminal determines that the trigger condition of the resource scheduling request is met.

Operation 22: The terminal sends the resource scheduling request to a base station, where the resource scheduling request is used to request the base station to allocate an uplink resource to the terminal, and the resource scheduling request includes at least any one of a priority indication of the service, a scheduling-free sending indication, a scheduling-free sending failure indication, a semi-persistent resource request, and a data buffer size indication.

The semi-persistent resource request includes service bearer information or a semi-persistent resource request instruction that is used to instruct the base station to allocate a semi-persistent resource.

The data buffer size indication is used to describe whether a data buffer size of the service is greater than/less than a threshold.

The scheduling-free sending indication includes resource information used to indicate that the terminal performs scheduling-free sending.

In one embodiment, the resource scheduling request includes the priority indication of the service and any one or any combination of the scheduling-free sending indication, the scheduling-free sending failure indication, and the data buffer size indication. In this case, the resource scheduling request is used to request the base station to allocate an uplink licensed resource to the terminal.

In one embodiment, the resource scheduling request includes the semi-persistent resource request and any one or a combination of the priority indication of the service and the data buffer size indication. In this case, the resource scheduling request is used to request the base station to allocate an uplink semi-persistent resource to the terminal.

In addition, each indication is represented by one bit. In the priority indication of the service, if the bit is 1, it indicates that a service of a high priority is included; or if the bit is 0, it indicates that a service of a high priority is not included. Optionally, a service bearer is a high priority bearer, and the service may be corresponding to one IP flow. If the bit is 1, it indicates that a service on a high priority slice (slice) is included. In one embodiment, different slices may represent that different physical layer frame structures or different transmission time intervals (TTI) are used. In the scheduling-free sending indication, if the bit is 1, it indicates that a scheduling-free (grant free) service is included; or if the bit is 0, it indicates that a scheduling-free service is not included. In the data buffer size indication, if the bit is 1, it indicates that the data buffer size of the service is greater than a threshold; or if the bit is 0, it indicates that the data buffer size of the service is lower than a threshold.

For example, two bits are used to indicate the priority indication of the service, and two bits are used to indicate the scheduling-free sending indication. One bit indicates whether there is a service on a high-priority logical channel, slice, or IP flow, and the other bit is used to indicate whether there is a service on a low-priority logical channel, slice, or IP flow. One bit indicates that there is a scheduling-free service, and the other bit indicates that there is a scheduling-based service.

Operation 23: The base station allocates the uplink resource to the terminal based on the resource scheduling request.

Specifically, when the base station allocates the uplink resource to the terminal based on the resource scheduling request, in one embodiment,

the base station allocates a corresponding uplink grant to the terminal based on the scheduling-free sending indication, the scheduling-free sending failure indication, or the data buffer size indication in the resource scheduling request. For example, the resource scheduling request includes the data buffer size indication, and when the data buffer size of the service is lower than a threshold, a grant A is allocated, or when the data buffer size of the service is higher than a threshold, a grant B is allocated. For example, the grant A can enable the terminal to send one BSR/one power headroom report (PHR) and data with a size of one small transport block (TB); or the grant A can enable the terminal to send data with a size of one small transport block. The size of one small transport block may be agreed on in advance or may be configured by the network. The grant B can enable the terminal to send data with a size of one big transport block, and the size of one big transport block may be agreed on in advance or may be configured by the network.

For example, when an unlicensed (unlicensed) spectrum is introduced into a secondary component carrier to perform sending by using the secondary component carrier assisted by a primary component carrier, UE 1 needs to send a resource scheduling request on the primary component carrier when directly sending data on the secondary component carrier in a scheduling-free manner. A scheduling-free sending indication in the resource scheduling request includes resource information used to indicate that the UE 1 performs scheduling-free sending, that is, a frequency and a resource that are used to indicate, on the primary component carrier, that the UE 1 performs scheduling-free sending, so that the base station can determine, based on the information, whether a plurality of UEs simultaneously send data on a same resource of a carrier. When the base station determines that another UE and the UE 1 simultaneously send data on the same resource, the base station performs resource allocation and scheduling for the UE 1 or the another UE, so as to improve resource sending efficiency. Optionally, if the base station correctly receives data of one UE in the plurality of UEs, the base station uses a scheduling manner or continues to use a scheduling-free manner to perform resource allocation and scheduling for other UEs; or if the base station does not correctly receive data of any UE, the base station uses a scheduling manner or continues to use a scheduling-free manner to perform resource allocation and scheduling for the UE 1 and/or other UEs.

In this case, the UE sends the resource scheduling request on a primary component carrier of a licensed spectrum, and directly sends data on a secondary component carrier of an unlicensed spectrum in a scheduling-free manner, so that the base station determines whether there is a resource conflict, and performs resource allocation and scheduling. The resource scheduling request and the data may be simultaneously sent. In this case, when receiving the resource scheduling request, the base station determines whether the data of the UE is received, and determines whether there is a conflict among a plurality of UEs. Optionally, the resource scheduling request may be sent before the data is sent. In this case, after receiving the resource scheduling request, the base station determines, after waiting for a time period, whether the data of the UE is received. The time period may be one or more LBT periods. Optionally, the resource scheduling request may alternatively be sent after the data is sent. In this case, after receiving the resource scheduling request, the base station determines whether the data of the UE is received before the resource scheduling request is received.

For example, in a standalone scenario, the UE sends the resource scheduling request on a preconfigured resource and frequency at a fixed moment in a time period, after LBT, in which a resource is allowed to be occupied for sending data (for example, a first timeslot or a last timeslot before the data is sent, or a preconfigured time period). The scheduling-free sending indication in the resource scheduling request includes the resource information that is used to instruct the UE to perform scheduling-free sending, and the resource information may be resource information selected by the UE or a number of a scheduling-free resource, so that the base station determines whether a resource conflict occurs, and performs resource allocation and scheduling, a data transmission latency on the unlicensed spectrum is reduced, and spectrum usage is improved. For example, according to a WLAN stipulation, the UE may occupy a spectrum for 10 ms to send the data, and it may be specified that the resource scheduling request instead of the data is sent by using the preconfigured resource at a specific moment in the 10 ms. Therefore, after simultaneously preempting the resource, the plurality of UEs send no data at the same time, but send resource scheduling requests by using resources that are not in conflict with each other, so as to ensure that the network can receive a related resource scheduling request.

In one embodiment, the scheduling-free sending indication may further include an SR, a BSR, information indicating that the terminal sends a related data transmission request on a preconfigured dedicated resource, a UE ID, a data volume that needs to be sent, and the like. The resource and the frequency that are occupied for sending the resource scheduling request are independently configured for each UE, so as to possibly ensure that no conflict occurs among UEs, or reduce a conflict probability. Therefore, when two or more UEs simultaneously send, after LBT, data by using a same scheduling-free resource, it may be ensured that resource indication information may be simultaneously sent at a fixed time (which is preconfigured by the base station by using a system message or in another manner), so that no conflict between uplink resources indicated in the resource indication information occurs.

When two UEs simultaneously send data using a same scheduling-free resource, and a conflict occurs during data sending, it may be ensured that the base station receives a scheduling-free sending indication, so as to perform resource allocation and scheduling for data transmission. For example, the base station allocates a licensed resource to the UE based on an SR in the scheduling-free sending indication, and the UE sends data based on the licensed resource after LBT. If there is no conflict, or the base station correctly receives data of one UE, after the data of the UE is transmitted, the base station does not need to perform resource allocation and scheduling for the data transmission, but only needs to send an ACK/NACK response based on a requirement.

It should be noted that the standalone scenario is a scenario in which a base station or an access point in 3GPP and a station in WLAN use a same spectrum resource (a same frequency or a same frequency band, or an unlicensed spectrum), and the base station works only on the same spectrum as the station in the WLAN, that is, none of cells controlled by the base station work on a frequency at which only a 3GPP cell is disposed. The cell controlled by the base station is a primary cell, and system information and another uplink or downlink control channel, including a feedback channel used after the UE receives downlink data, need to be sent in the cell. A data request and the like that need to be sent when the UE performs uplink scheduling need to be sent in the cell. For such system, sending is performed based on a TDD mode. To be specific, uplink data or downlink data can be sent in only a specific subframe.

When the base station allocates the uplink resource to the terminal based on the resource scheduling request, in a possible implementation, the base station determines a latency of the uplink grant based on the priority indication in the resource scheduling request. For example, for a service of a high priority, the base station allocates the uplink grant in a subframe or a symbol later, by N subframes or symbols, than a subframe or a symbol in which the resource scheduling request is received; and for a service of a low priority, the base station allocates the uplink grant in a subframe or a symbol later, by M subframes or symbols, than a subframe or a symbol in which the resource scheduling request is received. Values of N and M may be configured by the network or agreed on in a protocol, M is greater than or equal to N, and M and N are integers.

When the base station allocates the uplink resource to the terminal based on the resource scheduling request, in a possible implementation, when determining that the service bearer information in the resource scheduling request meets a preset condition, the base station allocates a semi-persistent resource to the terminal. In this case, a lifecycle of the semi-persistent resource and a radio network temporary identifier used for semi-persistent scheduling are agreed on in advance. Optionally, the resource scheduling request may further include the priority indication of the service and the data buffer size indication. The base station determines a latency of the semi-persistent resource based on the priority indication, and a higher priority indicates a smaller latency; and the base station determines a size of the semi-persistent resource based on the data buffer size indication.

When the base station allocates the uplink resource to the terminal based on the resource scheduling request, in a possible implementation, when determining that the resource scheduling request includes the semi-persistent resource request instruction that instructs the base station to allocate the semi-persistent resource, the base station allocates the semi-persistent resource to the terminal. In this case, a lifecycle of the semi-persistent resource and a radio network temporary identifier used for semi-persistent scheduling are agreed on in advance. Optionally, the resource scheduling request may further include the priority indication of the service and the data buffer size indication. The base station determines a latency of the semi-persistent resource based on the priority indication, and a higher priority indicates a smaller latency; and the base station determines a size of the semi-persistent resource based on the data buffer size indication.

In one embodiment, after the base station allocates the semi-persistent resource to the terminal, the method further includes:

when the base station detects that the service bearer information of the terminal does not meet the preset condition, actively releasing, by the base station, the semi-persistent resource, or instructing the terminal to release the semi-persistent resource.

After the base station allocates the semi-persistent resource to the terminal, when a service subsequently sent by the terminal is not carried on a specific logical channel, slice, or IP flow, the base station may actively release the semi-persistent resource, or instruct the terminal to release the semi-persistent resource.

In one embodiment, if the base station actively releases the semi-persistent resource, the terminal cannot initiate, within a time period after the semi-persistent resource is released, a resource scheduling request for requesting the semi-persistent resource.

In one embodiment, if the base station instructs the terminal to release the semi-persistent resource, the base station sends a release instruction to the terminal, the terminal enables a timer after receiving the release instruction, and before the timer expires, the terminal cannot initiate a resource scheduling request for requesting the semi-persistent resource. Even if the resource scheduling request for requesting the semi-persistent resource is initiated, the base station does not allocate a semi-persistent resource to the terminal.

In addition, after the base station allocates the semi-persistent resource to the terminal, generally, the base station does not release the semi-persistent resource by using explicit signaling, but releases the semi-persistent resource in an implicit manner. To be specific, the semi-persistent resource is released in an implicit manner when no data is transmitted between the terminal and the base station on the semi-persistent resource for a time period.

A lifecycle or a quantity of using times of the semi-persistent resource may be configured by default or preconfigured on the network side, and the semi-persistent resource is an uplink resource and/or a downlink resource. When the lifecycle of the semi-persistent resource is one TTI, the terminal may continuously use a persistent resource.

In one embodiment, after allocating the uplink resource to the terminal, the base station sends indication information of the resource to the terminal, and the indication information is used to indicate a type of the resource, a size of a corresponding time-frequency resource block, a frequency band or a frequency of the resource, or an identifier of a resource pool. In a design, low-latency and high-reliability resources are in a same resource pool, resources that support a high rate and large bandwidth are in a same resource pool, and resources that support non-emergency small-sized traffic sending are in a same resource pool.

It should be understood that, although the LTE system is used as an example in the foregoing embodiments, the foregoing embodiments may be applied to another communications system, and the communications system supports information exchange between base stations.

Based on the resource scheduling method provided in the foregoing embodiment, referring to FIG. 3, an embodiment of the present invention provides a resource apparatus 300, and the apparatus 300 is applied to a terminal. FIG. 3 is a schematic structural diagram of the apparatus 300 according to this embodiment of the present invention. As shown in FIG. 3, the apparatus 300 includes a sending unit 301 and a processing unit 302.

The processing unit 302 is configured to determine that a service that needs to be carried meets a trigger condition of sending a resource scheduling request.

The sending unit 301 is configured to send the resource scheduling request to a base station, where the resource scheduling request is used to request the base station to allocate an uplink resource to the terminal, and the resource scheduling request includes at least one of a priority indication of the service, a scheduling-free sending indication, a scheduling-free sending failure indication, a semi-persistent resource request, and a data buffer size indication.

In one embodiment, when determining that the service that needs to be carried meets the trigger condition of resource scheduling, the processing unit 302 is configured to:

when a data buffer size is empty, and new data of the service arrives, determine that the trigger condition of the resource scheduling request is met; or

when data that is of the service and that is carried on a channel, a slice, or an IP flow whose priority indication meets a preset condition arrives, determine that the trigger condition of the resource scheduling request is met; or

when determining that a service data volume of a service that is in the service and that is carried on a channel, a slice, or an IP flow whose priority indication meets a preset condition is greater than a first preset threshold, determine that the trigger condition of the resource scheduling request is met; or

when determining that a service data volume of the service is greater than a second preset threshold, determine that the trigger condition of the resource scheduling request is met; or

when determining that a service data volume of a scheduling-free service in the service is greater than a third preset threshold, determine that the trigger condition of the resource scheduling request is met; or

when determining that a data buffer size of a scheduling-based service in the service is greater than a fourth preset threshold, determine that the trigger condition of the resource scheduling request is met; or

when determining that a quantity of times that a scheduling-free service in the service fails to be sent is greater than a fifth preset threshold, determine that the trigger condition of the resource scheduling request is met.

In one embodiment, the semi-persistent resource request includes service bearer information or a semi-persistent resource request instruction that is used to instruct the base station to allocate a semi-persistent resource.

In one embodiment, the scheduling-free sending indication includes resource information used to indicate that the terminal performs scheduling-free sending.

In one embodiment, the processing unit 302 is further configured to: before determining that the service that needs to be carried meets the trigger condition of sending the resource scheduling request, determine that data of the service is carried on a pre-agreed logical channel, a specified slice, or a specified IP flow; or determine that data of the service is carried on a logical channel configured on a network side, a specified slice, or a specified IP flow.

It should be understood that division of the units in the foregoing apparatus 300 is merely logical function division. In actual implementation, all or some of the units may be integrated into one physical entity, or the units may be physically separated. For example, the foregoing units may be separately disposed processing elements, or may be integrated into a chip of the terminal for implementation, or may be stored in a memory element of the base station in a form of program code and invoked by a processing element of the terminal to implement functions of the foregoing units. In addition, the units may be integrated or may be implemented separately. The processing element may be an integrated circuit chip and has a signal processing capability. In an implementation process, the steps of the foregoing methods or the foregoing units may be performed by an integrated logical circuit in the form of hardware in a processor element or by an instruction in a form of software in a processor element. The processing element may be a general purpose processor, for example, a central processing unit (CPU), or may be configured as one or more integrated circuits that perform the foregoing methods, for example, one or more application-specific integrated circuits (ASIC), one or more microprocessors (DSP), or one or more field programmable gate arrays (FPGA), or the like.

It should be noted that, for a function implementation and an interaction manner of each unit in the apparatus 300 in this embodiment of the present invention, further refer to descriptions in a related method embodiment. Details are not described herein.

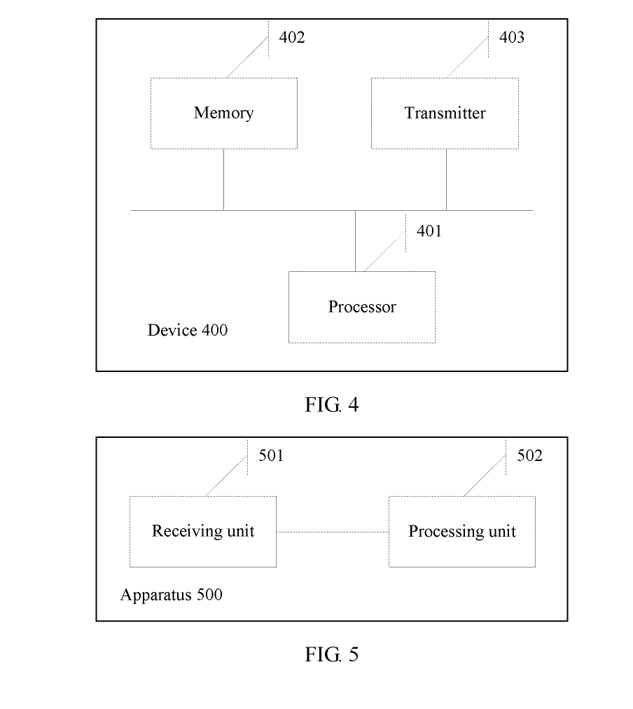

An embodiment of the present invention further provides a device 400, and the device 400 may be a terminal or another device located on the terminal. FIG. 4 is a schematic structural diagram of the device 400 according to this embodiment of the present invention. As shown in FIG. 4, the device 400 includes a processor 401, a memory 402, and a transmitter 403. Program code that is used to execute the solutions of the present invention is stored in the memory 402, and is controlled by the processor 401 for execution.

A program that is stored in the memory 402 is used to instruct the processor 401 to perform a resource scheduling method, including: determining a service that needs to be carried meets a trigger condition of sending a resource scheduling request; and sending the resource scheduling request to a base station by using the transmitter 403, where the resource scheduling request is used to request the base station to allocate an uplink resource to the terminal, and the resource scheduling request includes at least one of a priority indication of the service, a scheduling-free sending indication, a scheduling-free sending failure indication, a semi-persistent resource request, and a data buffer size indication.

In one embodiment, when determining that the service that needs to be carried meets the trigger condition of resource scheduling, the processor 401 is configured to:

when a data buffer size is empty, and new data of the service arrives, determine that the trigger condition of the resource scheduling request is met; or

when data that is of the service and that is carried on a channel, a slice, or an IP flow whose priority indication meets a preset condition arrives, determine that the trigger condition of the resource scheduling request is met; or

when determining that a service data volume of a service that is in the service and that is carried on a channel, a slice, or an IP flow whose priority indication meets a preset condition is greater than a first preset threshold, determine that the trigger condition of the resource scheduling request is met; or

when determining that a service data volume of the service is greater than a second preset threshold, determine that the trigger condition of the resource scheduling request is met; or

when determining that a service data volume of a scheduling-free service in the service is greater than a third preset threshold, determine that the trigger condition of the resource scheduling request is met; or

when determining that a data buffer size of a scheduling-based service in the service is greater than a fourth preset threshold, determine that the trigger condition of the resource scheduling request is met; or

when determining that a quantity of times that a scheduling-free service in the service fails to be sent is greater than a fifth preset threshold, determine that the trigger condition of the resource scheduling request is met.

In one embodiment, the semi-persistent resource request includes service bearer information or a semi-persistent resource request instruction that is used to instruct the base station to allocate a semi-persistent resource.

In one embodiment, the scheduling-free sending indication includes resource information used to indicate that the terminal performs scheduling-free sending.

In one embodiment, the processor 401 is further configured to: before determining that the service that needs to be carried meets the trigger condition of sending the resource scheduling request, determine that data of the service is carried on a pre-agreed logical channel, a specified slice, or a specified IP flow; or determine that data of the service is carried on a logical channel configured on a network side, a specified slice, or a specified IP flow.

It can be understood that the device 400 in this embodiment may be configured to implement all functions of the terminal involved in the foregoing method embodiment. For a specific implementation process, refer to the related description of the method executed by the terminal in the foregoing method embodiment. Details are not described herein.

Based on the resource scheduling method provided in the foregoing embodiment, referring to FIG. 5, an embodiment of the present invention provides a resource apparatus 500, and the apparatus 500 is applied to a base station. FIG. 5 is a schematic structural diagram of the apparatus 500 according to this embodiment of the present invention. As shown in FIG. 5, the apparatus 500 includes a receiving unit 501 and a processing unit 502.

The receiving unit 501 is configured to receive a resource scheduling request sent by a terminal, where the resource scheduling request is used to request the base station to allocate an uplink resource to the terminal, and the resource scheduling request includes at least one of a priority indication of the service, a scheduling-free sending indication, a scheduling-free sending failure indication, a semi-persistent resource request, and a data buffer size indication.

The processing unit 502 is configured to allocate the uplink resource to the terminal based on the resource scheduling request.

In one embodiment, the semi-persistent resource request includes service bearer information or a semi-persistent resource request instruction that is used to instruct the base station to allocate a semi-persistent resource.

In one embodiment, when allocating the uplink resource to the terminal based on the resource scheduling request, the processing unit 502 is specifically configured to:

allocate a corresponding uplink grant to the terminal based on the scheduling-free sending indication, the scheduling-free sending failure indication, or the data buffer size indication in the resource scheduling request; and

determine a latency of the uplink grant based on the priority indication in the resource scheduling request.

In one embodiment, when allocating the uplink resource to the terminal based on the resource scheduling request, the processing unit 502 is specifically configured to:

when determining that the service bearer information in the resource scheduling request meets a preset condition, allocate the semi-persistent resource to the terminal; or

when determining that the resource scheduling request includes the semi-persistent resource request instruction that instructs the base station to allocate the semi-persistent resource, allocate the semi-persistent resource to the terminal.

In one embodiment, the processing unit 502 is further configured to: after the semi-persistent resource is allocated to the terminal, and when it is detected that the service bearer information of the terminal does not meet the preset condition, actively release, by the base station, the semi-persistent resource, or instruct the terminal to release the semi-persistent resource.

It should be understood that division of the units in the foregoing apparatus 500 is merely logical function division. In actual implementation, all or some of the units may be integrated into one physical entity, or the units may be physically separated. For example, the foregoing units may be separately disposed processing elements, or may be integrated into a chip of the base station for implementation, or may be stored in a memory element of the base station in a form of program code and invoked by a processing element of the base station to implement functions of the foregoing units. In addition, the units may be integrated or may be implemented separately. The processing element may be an integrated circuit chip and has a signal processing capability. In an implementation process, the steps of the foregoing methods or the foregoing units may be performed by an integrated logical circuit in the form of hardware in a processor element or by an instruction in a form of software in a processor element. The processing element may be a general purpose processor, for example, a central processing unit (CPU), or may be configured as one or more integrated circuits that perform the foregoing methods, for example, one or more application-specific integrated circuits (ASIC), one or more microprocessors (DSP), or one or more field programmable gate arrays (FPGA), or the like.

It should be noted that, for a function implementation and an interaction manner of each unit in the apparatus 500 in this embodiment of the present invention, further refer to descriptions in a related method embodiment. Details are not described herein.

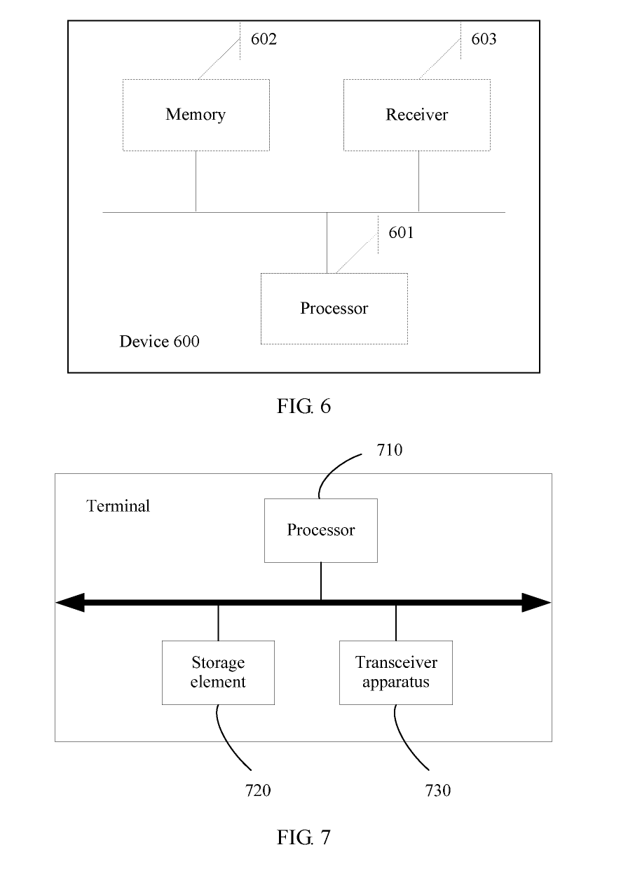

An embodiment of the present invention further provides a device 600, and the device 600 may be a base station or another device located on the base station. FIG. 6 is a schematic structural diagram of the device 600 according to this embodiment of the present invention. As shown in FIG. 6, the device 600 includes a processor 601, a memory 602, and a receiver 603. Program code that is used to execute the solutions of the present invention is stored in the memory 602, and is controlled by the processor 601 for execution.

A program that is stored in the memory 602 is used to instruct the processor 601 to perform a resource scheduling method, including: receiving, by using the receiver 603, a resource scheduling request sent by a terminal, where the resource scheduling request is used to request the base station to allocate an uplink resource to the terminal, and the resource scheduling request includes at least one of a priority indication of the service, a scheduling-free sending indication, a scheduling-free sending failure indication, a semi-persistent resource request, and a data buffer size indication; and allocating the uplink resource to the terminal based on the resource scheduling request.

In one embodiment, the semi-persistent resource request includes service bearer information or a semi-persistent resource request instruction that is used to instruct the base station to allocate a semi-persistent resource.

In one embodiment, when allocating the uplink resource to the terminal based on the resource scheduling request, the processor 601 is configured to: allocate a corresponding uplink grant to the terminal based on the scheduling-free sending indication, the scheduling-free sending failure indication, or the data buffer size indication in the resource scheduling request; and determine a latency of the uplink grant based on the priority indication in the resource scheduling request.

In one embodiment, when allocating the uplink resource to the terminal based on the resource scheduling request, the processor 601 is configured to: when determining that the service bearer information in the resource scheduling request meets a preset condition, allocate the semi-persistent resource to the terminal; or when determining that the resource scheduling request includes the semi-persistent resource request instruction that instructs the base station to allocate the semi-persistent resource, allocate the semi-persistent resource to the terminal.

In one embodiment, the processor 601 is further configured to: after the semi-persistent resource is allocated to the terminal, and when it is detected that the service bearer information of the terminal does not meet the preset condition, actively release, by the base station, the semi-persistent resource, or instruct the terminal to release the semi-persistent resource.

It can be understood that the processor involved in the device 400 and the device 600 in the embodiments of the present invention may be a general purpose central processing unit (CPU), a microprocessor, an application-specific integrated circuit application-specific integrated circuit (ASIC), or one or more integrated circuits configured to control program execution in the solutions of the present invention. One or more memories included in a computer system may be a read-only memory read-only memory (ROM) or a static storage device of another type, which is capable of storing static information and a static instruction, a random access memory random access memory (RAM) or a dynamic storage device of another type, which is capable of storing information and an instruction, or may be a magnetic disk memory. The memories are connected to the processor by using a bus.

Functions of the receiver and the transmitter may be implemented by using a transceiver, and the transceiver may be an entity module that is capable of implementing a transceiver function, so as to communicate with another device or another communications network.

The memory, for example, the RAM, stores an operating system and a program used to execute the solutions of the present invention. The operating system is a program that is used to control operating of another program and manage system resources.

The memory, transmitter, and receiver may be connected to the processor by using the bus, or may be separately connected to the processor by using a dedicated connection cable.

Code corresponding to the method described in the following is built into a chip by designing programming for the processor, so that when the chip runs, the method shown in FIG. 2 can be performed.

FIG. 7 is a schematic structural diagram of a terminal according to an embodiment of the present invention. As shown in FIG. 7, the terminal includes a processor 710, a storage element 720, and a transceiver apparatus 730. The transceiver apparatus 730 may be connected to an antenna. In a downlink direction, the transceiver apparatus 730 receives, by using the antenna, information sent by a base station, and sends the information to the processor 710 for processing. In an uplink direction, the processor 710 processes data of the terminal, and sends the data to the base station by using the transceiver apparatus 730.

The storage element 720 is configured to store program code that is used to implement the foregoing method embodiment or each unit in the foregoing embodiment shown in FIG. 3. The processor 710 invokes the program code, and performers operations in the foregoing method embodiment, to implement each unit shown in FIG. 3.

For example, the storage element 720 is configured to store program code that instructs the processor 710 to perform a resource scheduling method.

The processor 710 is configured to invoke the program code that is stored in the storage element 720, to perform the following steps: determining that a service that needs to be carried meets a trigger condition of sending a resource scheduling request; and sending the resource scheduling request to the base station, where the resource scheduling request is used to request the base station to allocate an uplink resource to the terminal, and the resource scheduling request includes at least one of a priority indication of the service, a scheduling-free sending indication, a scheduling-free sending failure indication, a semi-persistent resource request, and a data buffer size indication.

Some or all of the foregoing units may be built in a chip of the terminal in a field programmable gate array (FPGA) form. Further, the units may be independently implemented, or may be integrated.

Same as that in the foregoing description, the processing element herein may be a general purpose processor, for example, a central processing unit (CPU), or may be configured as one or more integrated circuits that perform the foregoing methods, for example, one or more application-specific integrated circuits (ASIC), one or more microprocessors (DSP), or one or more field programmable gate arrays (FPGA), or the like. The storage element may be a storage apparatus, or may be a general name for a plurality of storage elements.

In addition, a plurality of interfaces may be disposed on the processor, and are separately configured to connect to a peripheral device, or connect to an interface circuit that is connected to a peripheral device, for example, an interface configured to connect to a display screen, an interface configured to connect to a camera, an interface configured to connect to an audio processing element, and the like.

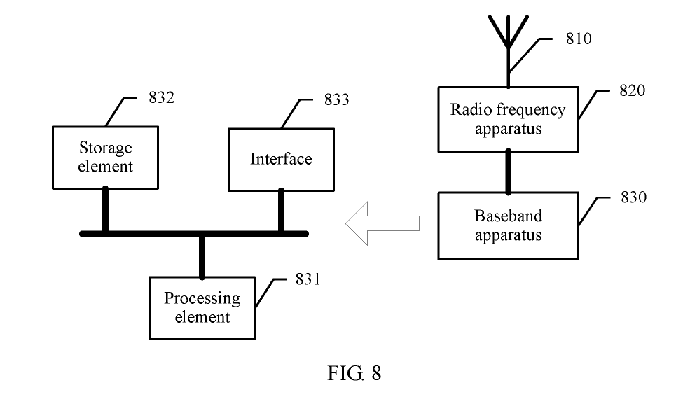

FIG. 8 is a schematic structural diagram of a base station according to an embodiment of the present invention. As shown in FIG. 8, the base station includes an antenna 810, a radio frequency apparatus 820, and a baseband apparatus 830. The antenna 810 is connected to the radio frequency apparatus 820. In an uplink direction, the radio frequency apparatus 820 receives, by using the antenna 810, information sent by a terminal, and sends, to the baseband apparatus 830 for processing, the information sent by the terminal. In a downlink direction, the baseband apparatus 830 processes the information of the terminal, and sends the information to the radio frequency apparatus 820. The radio frequency apparatus 820 processes the information of the terminal, and sends the information to the terminal by using the antenna 810.

The foregoing apparatus 500 may be located in the baseband apparatus 830, and includes a processing element 831 and a storage element 832. The baseband apparatus 830 may include, for example, at least one baseband board, and a plurality of chips are disposed on the baseband board. As shown in FIG. 8, one chip is, for example, the processing element 831, and is connected to the storage element 832, so as to invoke a program in the storage element 832, to perform the operation shown in the foregoing method embodiments. The baseband apparatus 830 may further include an interface 833, configured to exchange information with the radio frequency apparatus 820. The interface is, for example, a common public radio interface (common public radio interface, CPRI).

For another example, the processing unit 502 in FIG. 5 may be implemented by using a chip of the baseband apparatus 830, and the receiving unit 501 may be implemented by using another chip of the baseband apparatus 830; or the processing unit 502 and the receiving unit 501 are integrated into one chip of the baseband apparatus 830 for implementation; or functions of the processing unit 502 and the receiving unit 501 are stored in the storage element of the baseband apparatus 830 in a program code form, and are implemented through scheduling by a processing element of the baseband apparatus 830. Implementation of other units is similar to this.

According to another embodiment, a resource scheduling apparatus includes a receiving unit, configured to receive a resource scheduling request sent by a terminal, where the resource scheduling request is used to request a base station to allocate an uplink resource to the terminal, and the resource scheduling request comprises at least one of a priority indication of the service, a scheduling-free sending indication, a scheduling-free sending failure indication, a semi-persistent resource request, and a data buffer size indication; and a processing unit, configured to allocate the uplink resource to the terminal based on the resource scheduling request.

The semi-persistent resource request comprises service bearer information or a semi-persistent resource request instruction that is used to instruct the base station to allocate a semi-persistent resource. When allocating the uplink resource to the terminal based on the resource scheduling request, the processing unit is configured to allocate a corresponding uplink grant to the terminal based on the scheduling-free sending indication, the scheduling-free sending failure indication, or the data buffer size indication in the resource scheduling request; and determine a latency of the uplink grant based on the priority indication in the resource scheduling request.

When allocating the uplink resource to the terminal based on the resource scheduling request, the processing unit is configured to

when determining that the service bearer information in the resource scheduling request meets a preset condition, allocate the semi-persistent resource to the terminal; or
when determining that the resource scheduling request comprises the semi-persistent resource request instruction that instructs the base station to allocate the semi-persistent resource, allocate the semi-persistent resource to the terminal.

The processing unit is further configured to

after the semi-persistent resource is allocated to the terminal, and when it is detected that the service bearer information of the terminal does not meet the preset condition, actively release, by the base station, the semi-persistent resource, or instruct the terminal to release the semi-persistent resource.

Same as that in the foregoing description, the processing element herein may be a general purpose processor, for example, a central processing unit (Central Processing Unit, CPU), or may be configured as one or more integrated circuits that perform the foregoing methods, for example, one or more application-specific integrated circuits (Application Specific Integrated Circuit, ASIC), one or more microprocessors (digital signal processor, DSP), or one or more field programmable gate arrays (Field Programmable Gate Array, FPGA), or the like. The storage element may be a memory, or may be a general name for a plurality of storage elements.

Persons skilled in the art should understand that the embodiments of the present invention may be provided as a method, a system, or a computer program product. Therefore, the present invention may use a form of hardware only embodiments, software only embodiments, or embodiments with a combination of software and hardware. Moreover, the present invention may use a form of a computer program product that is implemented on one or more computer-usable storage media (including but not limited to a disk memory, a CD-ROM, an optical memory, and the like) that include computer-usable program code.

The present invention is described with reference to the flowcharts and/or block diagrams of the method, the device (system), and the computer program product according to the embodiments of the present invention. It should be understood that computer program instructions may be used to implement each process and/or each block in the flowcharts and/or the block diagrams and a combination of a process and/or a block in the flowcharts and/or the block diagrams. These computer program instructions may be provided for a general-purpose computer, a dedicated computer, an embedded processor, or a processor of any other programmable data processing device to generate a machine, so that the instructions executed by a computer or a processor of any other programmable data processing device generate an apparatus for implementing a specific function in one or more processes in the flowcharts and/or in one or more blocks in the block diagrams.

These computer program instructions may be stored in a computer readable memory that can instruct the computer or any other programmable data processing device to work in a specific manner, so that the instructions stored in the computer readable memory generate an artifact that includes an instruction apparatus. The instruction apparatus implements a specific function in one or more processes in the flowcharts and/or in one or more blocks in the block diagrams.

These computer program instructions may be loaded onto a computer or another programmable data processing device, so that a series of operations and steps are performed on the computer or the another programmable device, thereby generating computer-implemented processing. Therefore, the instructions executed on the computer or the another programmable device provide steps for implementing a specific function in one or more processes in the flowcharts and/or in one or more blocks in the block diagrams.

Although some preferred embodiments of the present invention have been described, persons skilled in the art can make changes and modifications to these embodiments once they learn the basic inventive concept. Therefore, the following claims are intended to be construed as to cover the preferred embodiments and all changes and modifications falling within the scope of the present invention.

Obviously, persons skilled in the art can make various modifications and variations to the embodiments of the present invention without departing from the spirit and scope of the embodiments of the present invention. The present invention is intended to cover these modifications and variations provided that they fall within the scope of protection defined by the following claims and their equivalent technologies.

What is claimed is:

1. A resource scheduling method, comprising:
determining, by a terminal, that a service that needs to be carried meets a trigger condition of sending a resource scheduling request; and
sending, by the terminal, the resource scheduling request to a base station, wherein the resource scheduling request is used to request the base station to allocate an uplink resource to the terminal, and the resource scheduling request comprises at least one of a priority indication of the service, a scheduling-free sending indication, a scheduling-free sending failure indication, a semi-persistent resource request, or a data buffer size indication.

2. The method according to claim 1, wherein the determining that a service that needs to be carried meets a trigger condition of resource scheduling comprises:
when a data buffer size is empty and new data of the service arrives, determining, by the terminal, that the trigger condition of the resource scheduling request is met; or
when data of the service carried on a channel, a slice, or an IP flow whose priority indication meets a preset condition arrives, determining, by the terminal, that the trigger condition of the resource scheduling request is met; or
when determining that a service data volume of a service that is in the service carried on a channel, a slice, or an IP flow whose priority indication meets a preset condition is greater than a first preset threshold, determining, by the terminal, that the trigger condition of the resource scheduling request is met; or
when determining that a service data volume of the service is greater than a second preset threshold, determining, by the terminal, that the trigger condition of the resource scheduling request is met; or
when determining that a service data volume of a scheduling-free service in the service is greater than a third preset threshold, determining, by the terminal, that the trigger condition of the resource scheduling request is met; or
when determining that a data buffer size of a scheduling-based service in the service is greater than a fourth preset threshold, determining, by the terminal, that the trigger condition of the resource scheduling request is met; or
when determining that a quantity of times that a scheduling-free service in the service fails to be sent is greater than a fifth preset threshold, determining, by the terminal, that the trigger condition of the resource scheduling request is met.

3. The method according to claim 1, wherein the semi-persistent resource request comprises service bearer information or a semi-persistent resource request instruction that is used to instruct the base station to allocate a semi-persistent resource.

4. The method according to claim 1, wherein the scheduling-free sending indication comprises resource information used to indicate that the terminal performs scheduling-free sending.

5. The method according to claim 1, wherein before determining that a service that needs to be carried meets a trigger condition of sending a resource scheduling request, the method further comprises:
determining, by the terminal, that data of the service is carried on a pre-agreed logical channel, a specified slice, or a specified IP flow; or
determining, by the terminal, that data of the service is carried on a logical channel configured on a network side, a specified slice, or a specified IP flow.

6. A resource scheduling method, comprising:
receiving, by a base station, a resource scheduling request from a terminal, wherein the resource scheduling request is used to request the base station to allocate an uplink resource to the terminal, and the resource scheduling request comprises at least one of a priority indication of the service, a scheduling-free sending indication, a scheduling-free sending failure indication, a semi-persistent resource request, or a data buffer size indication; and
allocating, by the base station, the uplink resource to the terminal based on the resource scheduling request.

7. The method according to claim 6, wherein the semi-persistent resource request comprises service bearer information or a semi-persistent resource request instruction that is used to instruct the base station to allocate a semi-persistent resource.

8. The method according to claim 6, wherein the allocating the uplink resource to the terminal based on the resource scheduling request comprises:
allocating, by the base station, a corresponding uplink grant to the terminal based on the scheduling-free sending indication, the scheduling-free sending failure indication, or the data buffer size indication in the resource scheduling request; and
determining, by the base station, a latency of the corresponding uplink grant based on the priority indication in the resource scheduling request.

9. The method according to claim 7, wherein the allocating the uplink resource to the terminal based on the resource scheduling request comprises:
when determining that the service bearer information in the resource scheduling request meets a preset condition, allocating, by the base station, the semi-persistent resource to the terminal; or
when determining that the resource scheduling request comprises the semi-persistent resource request instruction that instructs the base station to allocate the semi-persistent resource, allocating, by the base station, the semi-persistent resource to the terminal.

10. The method according to claim 8, wherein after the allocating the semi-persistent resource to the terminal, the method further comprises:
when the base station detects that the service bearer information of the terminal does not meet the preset condition, releasing, by the base station, the semi-persistent resource, or instructing the terminal to release the semi-persistent resource.

11. A resource scheduling apparatus, comprising:
a processing unit configured to determine that a service that needs to be carried meets a trigger condition of sending a resource scheduling request; and
a sending unit configured to send the resource scheduling request to a base station, wherein the resource scheduling request is used to request the base station to allocate an uplink resource to a terminal, and the resource scheduling request comprises at least one of a priority indication of the service, a scheduling-free sending indication, a scheduling-free sending failure indication, a semi-persistent resource request, or a data buffer size indication.

12. The apparatus according to claim 11, wherein when determining that the service that needs to be carried meets the trigger condition of resource scheduling, the processing unit is specifically configured to:
when a data buffer size is empty and new data of the service arrives, determine that the trigger condition of the resource scheduling request is met; or
when data of the service carried on a channel, a slice, or an IP flow whose priority indication meets a preset condition arrives, determine that the trigger condition of the resource scheduling request is met; or
when determining that a service data volume of a service that is in the service carried on a channel, a slice, or an IP flow whose priority indication meets a preset condition is greater than a first preset threshold, determine that the trigger condition of the resource scheduling request is met; or
when determining that a service data volume of the service is greater than a second preset threshold, determine that the trigger condition of the resource scheduling request is met; or
when determining that a service data volume of a scheduling-free service in the service is greater than a third preset threshold, determine that the trigger condition of the resource scheduling request is met; or
when determining that a data buffer size of a scheduling-based service in the service is greater than a fourth preset threshold, determine that the trigger condition of the resource scheduling request is met; or
when determining that a quantity of times that a scheduling-free service in the service fails to be sent is greater than a fifth preset threshold, determine that the trigger condition of the resource scheduling request is met.

13. The apparatus according to claim 11, wherein the semi-persistent resource request comprises service bearer information or a semi-persistent resource request instruction that is used to instruct the base station to allocate a semi-persistent resource.

14. The apparatus according to claim 11, wherein the scheduling-free sending indication comprises resource information used to indicate that the terminal performs scheduling-free sending.

15. The apparatus according to claim 11, wherein the processing unit is further configured to:
before determining that the service that needs to be carried meets the trigger condition of sending the resource scheduling request, determine that data of the service is carried on a pre-agreed logical channel, a specified slice, or a specified IP flow; or
determine that data of the service is carried on a logical channel configured on a network side, a specified slice, or a specified IP flow.
